(19) United States
(12) Patent Application Publication
(10) Pub. No.: US 2025/0054208 A1
(43) Pub. Date: Feb. 13, 2025

(54) PROCESSING APPARATUS, SYSTEM, BIOMETRIC AUTHENTICATION SYSTEM, PROCESSING METHOD, AND COMPUTER READABLE MEDIUM

(71) Applicant: NEC Corporation, Tokyo (JP)

(72) Inventors: Yoshimasa ONO, Tokyo (JP); Shigeru NAKAMURA, Tokyo (JP); Atsufumi SHIBAYAMA, Tokyo (JP); Junichi ABE, Tokyo (JP)

(73) Assignee: NEC Corporation, Tokyo (JP)

(21) Appl. No.: 18/926,835

(22) Filed: Oct. 25, 2024

Related U.S. Application Data
(63) Continuation of application No. 17/630,228, filed on Jan. 26, 2022.

(51) Int. Cl. G06T 11/00; G06F 21/32; G06T 15/04; G06T 15/08; G06V 40/12; G06V 40/13

(52) U.S. Cl. CPC G06T 11/005; G06T 11/006; G06T 15/04; G06T 15/08; G06V 40/1324; G06V 40/1359; G06V 40/1376; G06F 21/32; G06T 2207/10101

(57) ABSTRACT

Provided is a processing apparatus capable of obtaining a 2D image from 3D tomographic images, extracting an image for accurate authentication, and extracting an image at a high speed. A processing apparatus includes: means for calculating, from three-dimensional luminance data indicating an authentication target, depth dependence of striped pattern sharpness in a plurality of regions on a plane perpendicular to a depth direction of the target; means for calculating a depth at which the striped pattern sharpness is the greatest in the depth dependence of striped pattern sharpness; rough adjustment means for correcting the calculated depth on the basis of depths of other regions positioned respectively around the plurality of regions; fine adjustment means for selecting a depth closest to the corrected depth and at which the striped pattern sharpness is at an extreme; and means for extracting an image with a luminance on the basis of the selected depth.

This application is a Continuation of U.S. application Ser. No. 17/630,228 filed on Jan. 26, 2022, which is a National Stage Entry of PCT/JP2019/030364 filed on Aug. 1, 2019, the contents of all of which are incorporated herein by reference, in their entirety.

### TECHNICAL FIELD

The present disclosure relates to a processing apparatus, a system, a biometric authentication system, a processing method, and a computer readable medium for improving accuracy of authentication.

### BACKGROUND ART

As a technique for taking a tomographic image of a part of an object to be measured near the surface thereof, there is Optical Coherence Tomography (OCT) technology. In this OCT technology, a tomographic image of a part of an object to be measured near the surface thereof is taken by using interference between scattered light that is emitted from the inside of the object to be measured when a light beam is applied to the object to be measured (hereinafter referred to as “back-scattered light”) and reference light. In recent years, this OCT technology has been increasingly applied to medical diagnoses and inspections of industrial products.

The OCT technology has been practically used for tomographic imaging apparatuses for fundi of eyes in ophthalmic diagnoses, and has been studied in order to apply it as a noninvasive tomographic imaging apparatus for various parts of living bodies. In the present disclosure, attention is focused on a technique for dermal fingerprint reading using the OCT technology.

As a technique for using a fingerprint as biometric information, a biometric authentication technique using 2D (two-dimensional) image data of an epidermal fingerprint has been widely used. On the other hand, tomographic data of a finger acquired by using the OCT technology is luminance data at a 3D (three-dimensional) place. That is, in order to use data acquired by the OCT technology for the conventional fingerprint authentication based on 2D images, it is necessary to extract a 2D image containing features of the fingerprint from 3D tomographic data.

As a related art of the present invention, in Non-patent Literatures 1 and 2, a dermal fingerprint image is acquired by averaging tomographic luminance images over a predetermined range in the depth direction in tomographic data of a finger. However, a range of depths in which a dermal fingerprint is visually recognizable is hypothetically determined, and a fixed value is used for the predetermined range.

In Patent Literature 1, a luminance change in the depth direction is obtained for each pixel in a tomographic image. Then, a depth at which the luminance is the second highest is selected as a depth at which a dermal fingerprint is visually recognizable, and an image at this depth having the luminance is used as a dermal fingerprint image.

In Non Patent Literature 3, Orientation Certainty Level (OCL) indicating unidirectionality of a fingerprint pattern in a sub-region is calculated for epidermal and dermal fingerprint images. Then, an image for each sub-region is determined through fusion of the epidermal and dermal fingerprint images on the basis of the OCL value.

### CITATION LIST

### Patent Literature

Patent Literature 1: United States Patent Publication No. 2017/0083742

### Non Patent Literature

Non Patent Literature 1: A. Bossen, R. Lehmann and C. Meier, “Internal fingerprint identification with optical coherence tomography”, IEEE Photonics Technology Letters, vol. 22, no. 7, 2010

Non Patent Literature 2: M. Liu and T. Buma, “Biometric mapping of fingertip eccrine glands with optical coherence tomography”, IEEE Photonics Technology Letters, vol. 22, no. 22, 2010

Non Patent Literature 3: L. Darlow and J. Connan, “Efficient internal and surface fingerprint extraction and blending using optical coherence tomography”, Applied Optics, Vol. 54, No. 31, (2015)

Non Patent Literature 4: E. Lim, et. al., “Fingerprint image quality analysis”, ICIP 2004, vol. 2, 1241-1244, (2004)

Non Patent Literature 5: E. Lim, X. Jiang and W. Yau, “Fingerprint quality and validity analysis”, ICIP 2002, vol. 1, 469-472, (2002)

Non Patent Literature 6: T. Chen X. Jiang and W. Yau, “Fingerprint image quality analysis”, ICIP 2004, vol. 1, 1253-1256, (2004)

### SUMMARY OF INVENTION

### Technical Problem

In the above-mentioned Non-patent Literatures 1 and 2, since the averaging process is performed for tomographic luminance images over the fixed range of depths, differences of thicknesses of epidermises among individuals are not taken into consideration. For example, when an epidermis has been worn or has become thick due to the occupation, the averaging may be performed over a range of depths that is deviated from the range of depths in which a dermal fingerprint is clearly visually recognizable, therefore making it difficult to obtain a clear dermal fingerprint image. In addition, since an interface between an epidermis and a dermis in which a dermal fingerprint is clearly visible is likely to distort in a depth direction, a fingerprint image extracted in a uniform depth may be locally blurred.

In the aforementioned Patent Literature 1, since the depth at which a dermal fingerprint is clearly visible is determined for each pixel in a tomographic image, the measurement is likely to be affected by noises caused by the measuring apparatus using the OCT technology itself, so that there is a high possibility that the depth is incorrectly determined. Further, since the process for determining a depth is performed for each pixel in a tomographic image, it takes time to extract a dermal fingerprint image.

In the aforementioned Non Patent Literature 3, a technique of obtaining a fingerprint image from two images, that are epidermal and dermal fingerprint images, is explained, that is different from the technique of obtaining an optimum fingerprint image from a plurality of tomographic images that are successive in the depth direction as described in the present disclosure. Further, in the tomographic images that are successive in the depth direction, the OCL calculated after dividing into regions is generally susceptible to noise, leading to a high possibility of erroneous selection of a depth that is not optimal.

An object of the present disclosure is to provide a processing apparatus, a system, a biometric authentication system, a processing method, and a computer readable medium for solving any one of the above-described problems.

### Solution to Problem

A processing apparatus according to the present disclosure includes:
means for calculating, from three-dimensional luminance data indicating an authentication target, depth dependence of striped pattern sharpness in a plurality of regions on a plane perpendicular to a depth direction of the authentication target;
means for calculating a depth at which the striped pattern sharpness is the greatest in the depth dependence of striped pattern sharpness;
rough adjustment means for correcting the calculated depth on the basis of depths of other regions positioned respectively around the plurality of regions;
fine adjustment means for selecting a depth closest to the corrected depth and at which the striped pattern sharpness is at an extreme; and
means for extracting an image with a luminance on the basis of the selected depth.

A processing method according to the present disclosure includes:
a step of calculating, from three-dimensional luminance data indicating an authentication target, depth dependence of striped pattern sharpness in a plurality of regions on a plane perpendicular to a depth direction of the authentication target;
a step of calculating a depth at which the striped pattern sharpness is the greatest in the depth dependence of striped pattern sharpness;
a step of correcting the calculated depth on the basis of depths of other regions positioned respectively around the plurality of regions;
a step of selecting a depth closest to the corrected depth and at which the striped pattern sharpness is at an extreme; and
a step of extracting an image with a luminance on the basis of the selected depth.

A non-transitory computer readable medium storing a program according to the present disclosure causes a computer to perform:
a step of calculating, from three-dimensional luminance data indicating an authentication target, depth dependence of striped pattern sharpness in a plurality of regions on a plane perpendicular to a depth direction of the authentication target;
a step of calculating a depth at which the striped pattern sharpness is the greatest in the depth dependence of striped pattern sharpness;
a step of correcting the calculated depth on the basis of depths of other regions positioned respectively around the plurality of regions;
a step of selecting a depth closest to the corrected depth and at which the striped pattern sharpness is at an extreme; and
a step of extracting an image with a luminance on the basis of the selected depth.

### Advantageous Effects of Invention

According to the present disclosure, it is possible to provide a processing apparatus, a system, a biometric authentication system, a processing method, and a computer readable medium capable of obtaining a 2D image from 3D tomographic images, extracting an image for accurate authentication, and extracting an image at a high speed.

### BRIEF DESCRIPTION OF THE DRAWINGS

FIG. 1 is a block diagram showing an example of a fingerprint image extraction processing apparatus according to an example embodiment;

FIG. 2 is a block diagram showing an example of a system according to an example embodiment;

FIG. 3 shows an example of an operation for extracting a fingerprint image on the basis of striped pattern sharpness in regions according to a first example embodiment;

FIG. 4 shows an example of an operation for optimizing an extraction depth through correction of a deviated depth and selection of a local optimal value of the striped pattern sharpness according to the first example embodiment;

FIG. 5 is a flowchart showing an example of processing for extracting a fingerprint image according to the first example embodiment;

FIG. 6 shows an example of an operation for extracting a fingerprint image through repetition of the processing for correcting a deviated depth according to a second example embodiment;

FIG. 7 is a flowchart showing an example of processing for extracting a fingerprint image according to the second example embodiment;

FIG. 8 shows an example of an operation for extracting a fingerprint image after limiting a range of a searched depth according to a third example embodiment;

FIG. 9 is a flowchart showing an example of processing for extracting a fingerprint image according to the third example embodiment;

FIG. 10 shows an example of an operation of processing for estimating spatial frequency of a fingerprint according to a fourth example embodiment;

FIG. 11 is a flowchart showing an example of processing for extracting an authentication image according to the fourth example embodiment; and

FIG. 12 shows an example of a hardware configuration included in an authentication image extraction apparatus.

### DESCRIPTION OF EMBODIMENTS

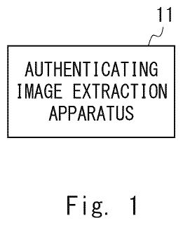

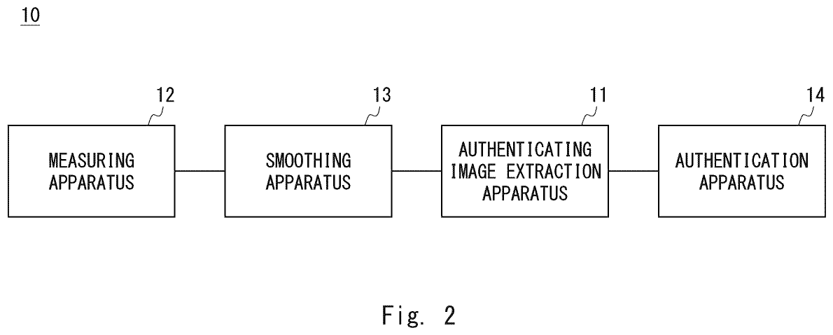

Example embodiments according to the present invention will be described hereinafter with reference to the drawings. As shown in FIG. 1, an authenticating image extraction apparatus 11 according to an example embodiment is an apparatus for extracting an image or the like used for authentication of a fingerprint and the like, and details thereof will be described in the descriptions of example embodiments shown below. As shown in FIG. 2, a system 10 according to the example embodiment includes a measuring apparatus 12, a smoothing apparatus 13, the authenticating image extraction apparatus 11, and an authentication apparatus 14.

The measuring apparatus 12 captures 3D (three-dimensional) tomographic luminance data indicating luminance of an authentication target to be authenticated in a 3D space by using the OCT technology or the like. The authentication target is not particularly limited and may be various types of objects. A specific example thereof is a part of a living body. A more specific example thereof is a finger of a hand. The smoothing apparatus 13 smooths curvatures in the authentication target in the depth direction thereof in the 3D tomographic luminance data acquired by the measuring apparatus 12. Even when the measuring apparatus 12 is an apparatus in which the authentication target, e.g., a fingerprint, is acquired in a non-contact manner, or by pressing the authentication target against a glass surface or the like, the roundness of the authentication target remains. Therefore, the smoothing apparatus 13 smooths curvatures in the authentication target in the depth direction before a process for extracting an authentication image is performed, and generates the 3D luminance data. The authentication apparatus 14 performs authentication by using the extracted authentication image. The authentication apparatus 14 performs biometric authentication by using, for example, a fingerprint image. Specifically, the authentication apparatus 14 identifies an individual by finding matching between a tomographic image and image data associated with individual information, and comparing the tomographic image with the image data associated with the individual information. The system 10 shown in FIG. 2 is capable of performing authentication of a living body.

In the following descriptions of example embodiments, the authentication target is a finger of a hand. In addition, a depth from a surface of an epidermis of a finger to the inside of the skin is referred to as a depth, and a plane perpendicular to the depth direction is referred to as an XY-plane. Further, a luminance image on the XY-plane is referred to as a tomographic image.

### First Example Embodiment

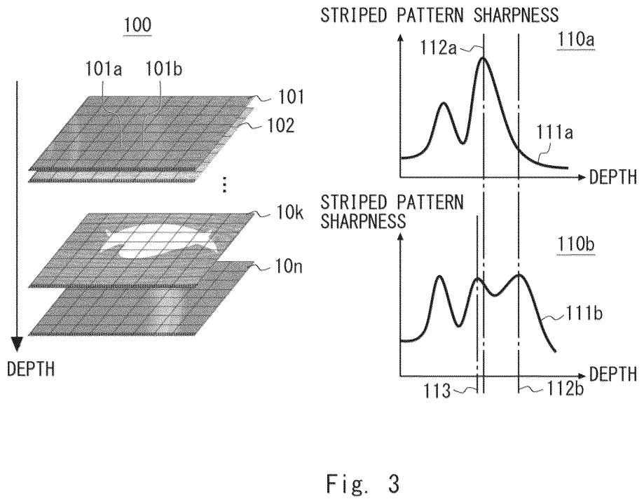

FIG. 3 shows an example of an operation for extracting a fingerprint image on the basis of striped pattern sharpness in a region according to a first example embodiment. In other words, FIG. 3 shows images and a graph for showing an example of an operation of a process for extracting an authentication image on the basis of depth dependence of striped pattern sharpness according to the first example embodiment of the present invention. Data output from the measuring apparatus 12 through the smoothing apparatus 13 indicates luminance in each place in a 3D space, and can be represented by tomographic images 101, 102, . . . 10k, . . . , and 10n at respective depths as shown in a tomographic image group 100 in FIG. 3. Note that k is a natural number and n is the total number of tomographic images. The tomographic images are each divided into a plurality of regions on the XY-plane, and regions 101a and 101b mean regions belonging to the tomographic image 101.

An epidermal fingerprint and a dermal fingerprint on a finger are shown most clearly in an interface between the air and an epidermis, and an interface between an epidermis and a dermis, respectively. Given this, in the present application, a depth at which the striped pattern sharpness of the tomographic image is high is selected as a depth at which various types of fingerprints are extracted. Further, in consideration of possibility of distortion of the aforementioned interfaces of the air, an epidermis, and a dermis in the depth direction, a method is employed in which the 3D luminance data is divided into predetermined regions on the XY-plane, and a depth at which each region has high striped pattern sharpness is selected.

The striped pattern sharpness means a feature amount, such as OCL (Orientation Certainty Level) used in Non Patent Literature 3, indicating that there are a plurality of stripes of the same shape consisting of light and dark portions in an image. Examples of the striped pattern sharpness include OCL, RVU (Ridge Valley Uniformity), FDA (Frequency Domain Analysis), and LCS (Local Clarity Score). OCL is disclosed in Non Patent Literature 4. RVU indicates uniformity of widths of light and dark stripes in a sub-region. FDA indicates a mono-frequency characteristic of a striped pattern in a sub-region disclosed in Non Patent Literature 5. LCS indicates uniformity of luminance of each of light and dark portions of stripes in a sub-region disclosed in Non Patent Literature 6. Other examples of the striped pattern sharpness include OFL (Orientation Flow) indicating continuity of a stripe direction with surrounding sub-regions. The striped pattern sharpness may also be defined as a combination of these evaluation indicators.

The depth dependences 110a and 110b of striped pattern sharpness shown in FIG. 3 are obtained by calculating the striped pattern sharpness for tomographic images 101 to 10n on the same XY-plane as the regions 101a, 101b and graphically shown. In the graph 111a, the highest value of the striped pattern sharpness is found at the depth 112a, while in the graph 111b, the highest value of the striped pattern sharpness is found at the depth 112b.

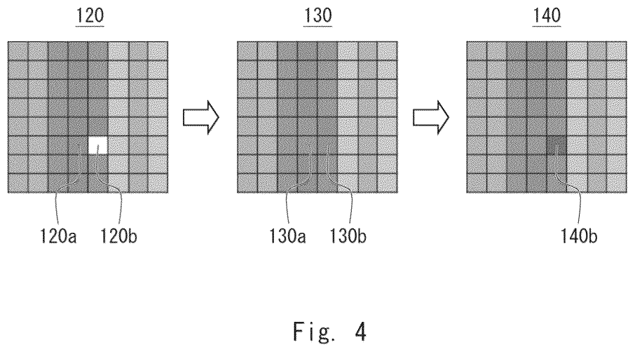

FIG. 4 shows an example of an operation for optimizing an extraction depth through correction of a deviated depth and selection of a local optimal value of the striped pattern sharpness according to the first example embodiment. In other words, FIG. 4 is a drawing for explaining an operation for optimizing a selected depth in regions according to the first example embodiment of the present invention. The depth images 120, 130, and 140 shown in FIG. 4 are depth images in which a pixel is the depth selected in a divided region.

The depth image 120 includes a pixel 120a indicating the depth 112a in the graph 111a shown in FIG. 3, and a pixel 120b indicating the depth 112b in the graph 111b. In regard to other regions as well, an example of applying a depth at which the striped pattern sharpness is the greatest to a pixel is shown in a similar manner.

The depth 112b in the region corresponding to the pixel 120b is largely different from the depths of pixels around the region corresponding to the pixel 120b. In the case of calculating a feature amount through division into a plurality of regions, it is difficult to sufficiently suppress an influence of noise from a measurement device and the like. For example, in the region corresponding to the pixel 120b as in the graph 111b, the depth at which the striped pattern sharpness is the greatest is defined as the depth 112b. However, the depth 113 is close to the depth 112a and considered to be a correct value as a depth at which various fingerprints are to be extracted. Therefore, defining the depth at which the striped pattern sharpness is the greatest as the depth 112b results in generation of an error. In this regard, in the present application, attention is focused on a tendency of succession of distortion or displacement in the depth direction of interfaces in the skin structure, and processing is performed for correcting the depth deviated from the depths of other regions positioned around the region so as to select the depth equal or close to the surrounding depths. Examples of means for correcting the depth of the region deviated from the depths of the surrounding regions include: image processing such as a median filter and a bilateral filter; and filters employing spatial frequency such as a low-pass filter and a Wiener filter.

The depth image 130 shown in FIG. 4 shows an example of subjecting the depth image 120 to the processing for correcting the deviated depth, in which the pixel 130b indicates the depth converted to a value similar to the surrounding depths. In this example, the depth indicated by the pixel 130b has been converted to the depth 112a as in the pixel 130a. The depth indicated by the pixel 130b is similar to the surrounding depths, but is not the depth with the optimal striped pattern sharpness. Given this, the depth is finely adjusted by selecting the depth 113 at which the striped pattern sharpness is the maximum around the depth 112a in the graph 111b.

The depth image 140 shown in FIG. 4 is a result of performing fine adjustment of the optimal depth with respect to the depth image 130 by reusing the depth dependence of the striped pattern sharpness. The depth 113 has been selected, and the depth of the pixel 140b has been converted to the same depth as the depth 113.

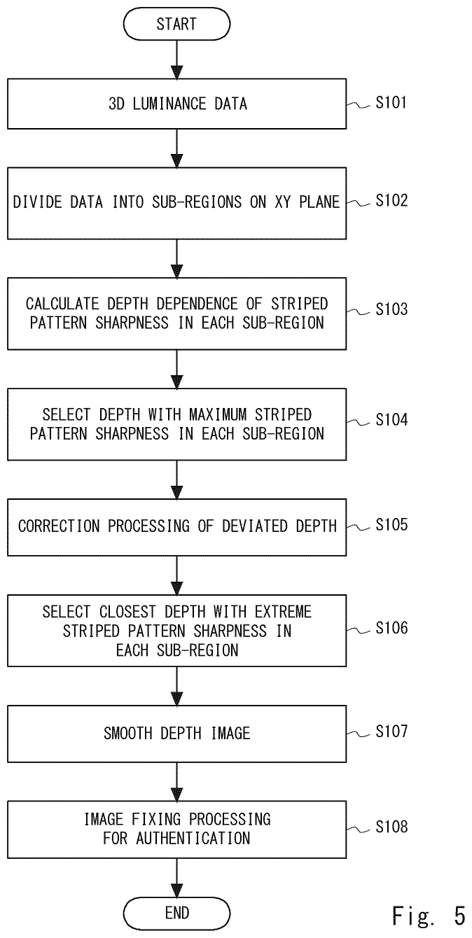

FIG. 5 is a flowchart showing an example of processing for extracting a fingerprint image according to the first example embodiment of the present invention.

The authenticating image extraction apparatus 11 acquires 3D luminance data (Step S101). The authenticating image extraction apparatus 11 divides the 3D luminance data into a plurality of regions on the XY-plane (Step S102). Note that the shapes of the plurality of regions are various, and not limited to a grid shape.

The authenticating image extraction apparatus 11 calculates the depth dependence of the striped pattern sharpness in each region (Step S103). Note that, as described above, the striped pattern sharpness means a feature amount indicating that there are a plurality of stripes of the same shape consisting of light and dark portions in an image, exemplified by OCL.

The authenticating image extraction apparatus 11 selects the depth at which the striped pattern sharpness is the greatest in each region (Step S104). The authenticating image extraction apparatus 11 corrects the depth deviated from the depths of surrounding regions to the selected depth (Step S105). Note that, in the case of the depth image, examples of a method for correcting the deviated depth include processing such as a median filter.

The authenticating image extraction apparatus 11 selects the depth at which the striped pattern sharpness is at an extreme in each region, and which is the closest to the selected depth (Step S106). The authenticating image extraction apparatus 11 converts depth information divided into regions to the same definition as the fingerprint image, to thereby smooth the depth information (Step S107). The authenticating image extraction apparatus 11 performs processes for adjusting an image for biometric authentication, such as conversion into a two-greyscale image and a thinning process (Step S108).

As described above, the authentication image extraction system according to the first example embodiment divides the 3D luminance data of a finger into regions on the XY-plane, and optimizes the extraction depth through use of the striped pattern sharpness. Further, the authentication image extraction system is capable of extracting a clear fingerprint image at a high speed, by means of rough adjustment of the depth through correction processing of the deviated depth, and fine adjustment of the depth through selection of the extreme value of the striped pattern sharpness. As a result, compared to the techniques disclosed in Non Patent Literatures 1 and 2, it is possible to extract an image in an adaptive manner against differences of thicknesses of epidermises among individuals, and to respond to distortion in the depth direction of interfaces in the skin structure.

Further, since a depth is determined based on an image having a plurality of pixels, unlike the depth determination by a single pixel disclosed in Patent Literature 1, the tolerance to noises is high. Further, since the data to be processed is also the number of regions, the processing can be performed at a high speed.

By additionally performing the processing for correcting the deviated depth, it is made possible to stably extract a clear fingerprint image with respect to the depth optimization in a region susceptible to noise.

### Second Example Embodiment

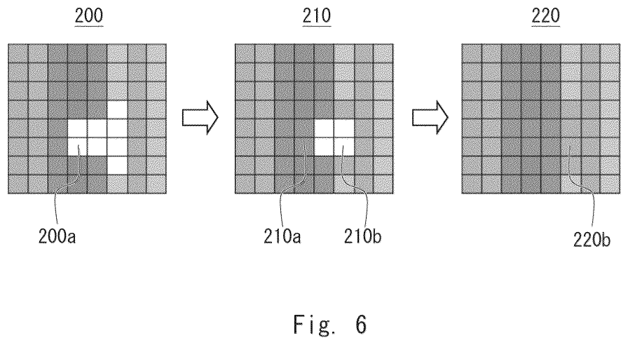

In a second example embodiment, processing for stabilizing extraction of a clear fingerprint image through repetition of the correction processing of the deviated depth in the first example embodiment is described. FIG. 6 is a drawing for explaining an example of an operation for the correction processing of the depth image according to the second example embodiment of the present invention. In other words, FIG. 6 shows an example of an operation for extracting a fingerprint image through repetition of processing for correcting a deviated depth according to the second example embodiment.

A depth image 200 shown in FIG. 6 is a depth image after selection of the depth at which the striped pattern sharpness is the greatest in each region, as with the depth image 120 in the first example embodiment. Unlike the depth image 120, the depth image 200 has a large number of pixels of regions with deviated depths, and the deviated depths may remain after performing the processing for correcting the depth only once. Given this, stable extraction processing of a fingerprint image is made possible even with a large number of pixels with deviated depths, by repeatedly performing the processing for correcting a deviated depth and the processing for selecting the depth at which the striped pattern sharpness is at an extreme, and which is the closest to the selected depth.

The depth image 210 shown in FIG. 6 is obtained after performing the processing for correcting a deviated depth once, in which the pixel 200a can be corrected to indicate a depth value of the same level as the surrounding pixels, for example as the pixel 210a. However, a pixel indicating a depth deviating from the surrounding depths, such as the pixel 210b, remains. Given this, by additionally performing the processing for correcting the deviated depth and the processing for selecting the closest depth at which the striped pattern sharpness is at an extreme, the depth image 220 is obtained, and the depth of the pixel 210b can be made to be similar to the surrounding pixels, like the pixel 220b.

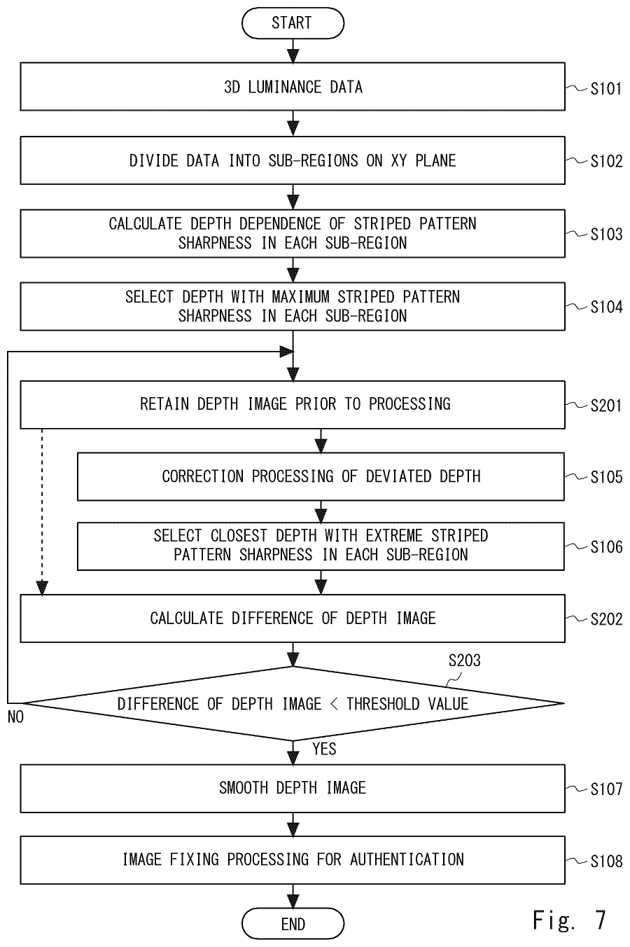

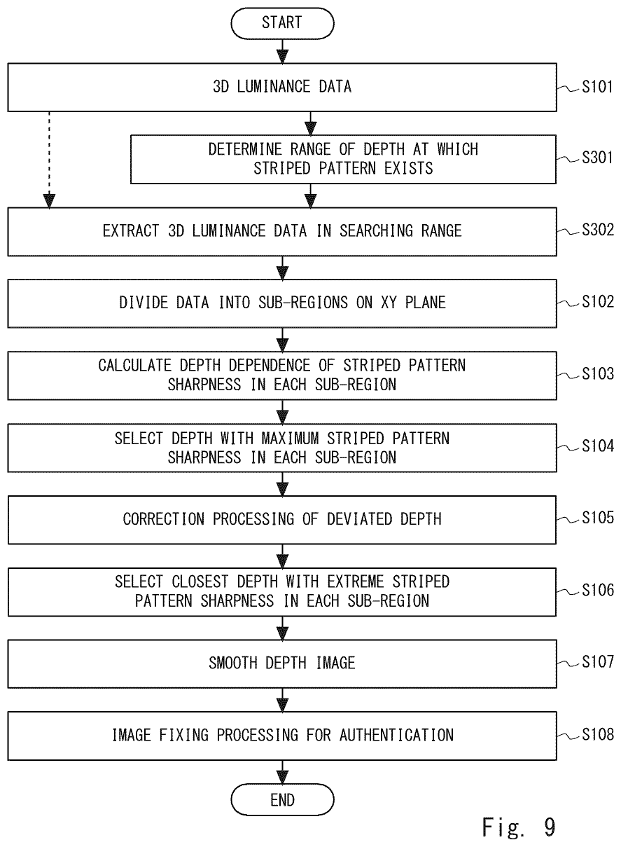

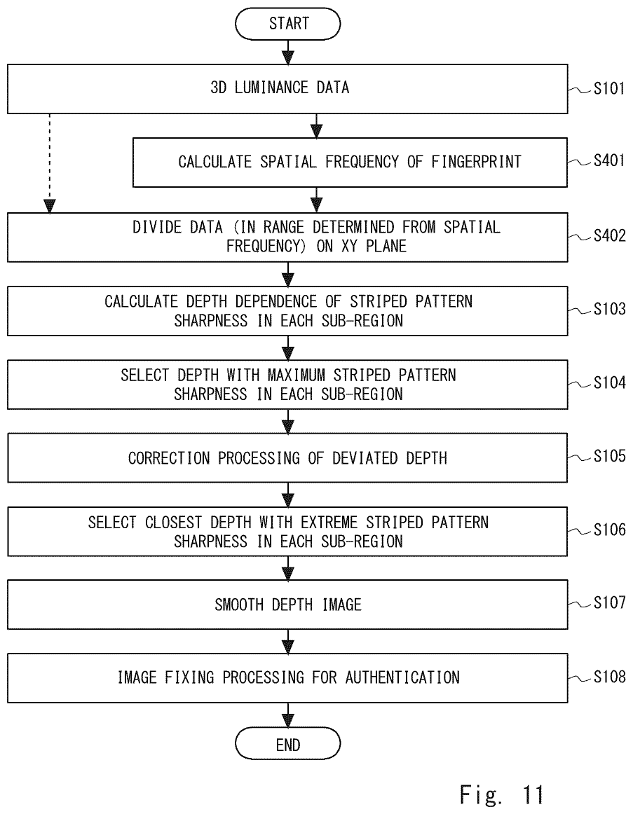

FIG. 7 is a flowchart showing an example of processing for extracting a fingerprint image according to the second example embodiment of the present invention. As shown in FIG. 7, Step S101 to Step S104 are performed as in the first example embodiment. Note that solid-line arrows in FIG. 7 as well as FIGS. 9 and 11 showing flowcharts indicate a flow of the processing method. Doted-line arrows in these drawings indicate flows of data such as images in a supplemental manner, and do not indicate the flow of the processing method.

After Step S104, the authenticating image extraction apparatus 11 retains the depth image output by Step S104 to Step S203 (Step S201). The depth image retained in Step S201 is subjected to the processing of Step S105 and Step $106 as in the first example embodiment.

After Step S106, the authenticating image extraction apparatus 11 calculates a difference between the depth image retained in Step S201 and the depth image after Step S106 (Step S202). Any method for calculating a difference between two depth images can be employed.

In a case in which the difference value calculated in Step S202 is smaller than a threshold value (Step S203: Yes), the authenticating image extraction apparatus 11 terminates the processing for correcting the deviated depth. In a case in which the difference value calculated in Step S202 is no less than the threshold value (Step S203: No), the authenticating image extraction apparatus 11 returns to Step S201 and repeats the processing for correcting the deviated depth. After Step S203, the authenticating image extraction apparatus 11 performs Step S107 and Step S108 as in the first example embodiment.

As described above, in addition to the first example embodiment, the authentication image extraction system in the second embodiment repeats the rough adjustment of the depth through correction processing of the deviated depth, and the fine adjustment of the depth through selection of the depth with the extreme value of the striped pattern sharpness. As a result, stable extraction of a clear fingerprint image is enabled even with a large number of regions with deviated depths.

### Third Example Embodiment

In a third example embodiment, processing for extracting an epidermal fingerprint and a dermal fingerprint through limitation of a searching range for a target depth in the first and second example embodiments is described. In general, with respect to the 3D luminance data of a finger, the striped pattern sharpness is the maximum at depths of an interface between the air and an epidermis and an interface between an epidermis and a dermis, respectively corresponding to an epidermal fingerprint and a dermal fingerprint. The first and second example embodiments are in a mode of converging into a maximum value and not capable of acquiring two fingerprint images. Given this, in the present example embodiment, a method for extracting two fingerprint images through limiting respective searching ranges is described.

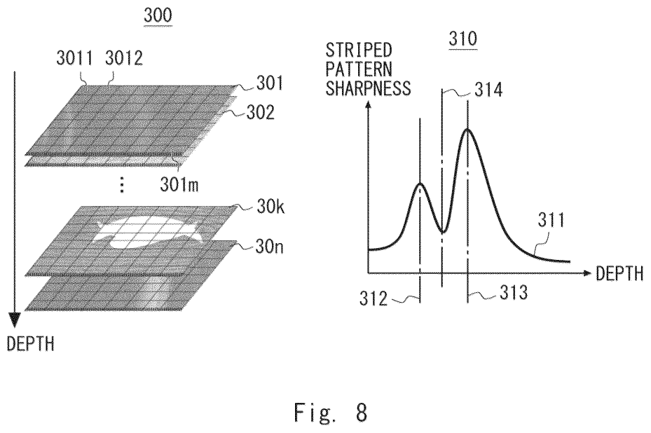

FIG. 8 shows an example of an operation for extracting a fingerprint image after limiting a searching range of an extraction depth according to the third example embodiment of the present invention. A tomographic image group 300 shown in FIG. 8 is composed of tomographic images 301, 302, . . . 30k, . . . , and 30n at respective depths. Note that k is a natural number and n is the total number of tomographic images. Each tomographic image is divided into regions on the XY-plane, and the tomographic image 301 is composed of regions 3011, 3012, . . . , and 301m. Note that m is the total number of regions per tomographic image.

The depth dependence 310 of the striped pattern sharpness shown in FIG. 8 indicates the striped pattern sharpness of the tomographic images at respective depths. Examples of the striped pattern sharpness at respective widths include an average value of OCL. In the case of the tomographic image 301, this corresponds to an average value of OCL values of the regions 3011 to 301m.

In the graph 311, the striped pattern sharpness is the maximum at the depths 312 and 313, corresponding to average depths of an interface between the air and an epidermis and an interface between an epidermis and a dermis, respectively. For example, by limiting the searching range to a range in the depth direction from the depth 314, which is a median value of the depths 312 and 313, extraction of a dermal fingerprint according to the first and second example embodiment is made possible.

By thus calculating and comparing the average striped pattern sharpness of each tomographic image, it is possible to estimate approximate depths corresponding to the epidermal and dermal fingerprint images and to extract the respective fingerprint images. Although a technique of calculating the striped pattern sharpness of a tomographic image by using the average value of OCL has been described, the maximum value of luminance may also be used instead of the striped pattern sharpness.

FIG. 9 is a flowchart showing an example of processing for extracting an authentication image according to the third example embodiment of the present invention. The authenticating image extraction apparatus 11 according to the third example embodiment performs Step S101 as in the first example embodiment. Next, the authenticating image extraction apparatus 11 determines a searching range for a depth at which a striped pattern exists (Step S301). The means for determining the searched depth is exemplified by, but not limited to, the aforementioned method of using the depth at which an average value of OCL is the maximum.

Next, the authenticating image extraction apparatus 11 extracts 3D luminance data within the range of the searched depth determined in Step S301 (Step S302). The authenticating image extraction apparatus 11 according to the third example embodiment performs Step S102 to Step S108 as in the first example embodiment.

As described above, the authentication image extraction system according to the third example embodiment makes it possible to independently acquire two types of fingerprints, which are an epidermal fingerprint and a dermal fingerprint, through limitation of the range of searched depth.

### Fourth Example Embodiment

In a fourth example embodiment, processing for changing a range of a region to be divided on the XY-plane in the first to third example embodiments in an adaptive manner depending on a finger to be recognized is described. For example, OCL is an amount indicating that a striped pattern within a region is unidirectional; however, when the range of the region is excessively extended, the fingerprint within the region is no longer a unidirectional striped pattern. To the contrary, when the range of the region is narrowed, the striped pattern disappears. Since an interval of the striped pattern varies from person to person, it is desirable that the region is not fixed and is changeable in an adaptive manner depending on a finger to be recognized. Given this, in the fourth example embodiment, the range of a region to be divided on the XY-plane is determined after estimating spatial frequency of a fingerprint, and then the fingerprint extraction processing according to the first to third example embodiments is performed.

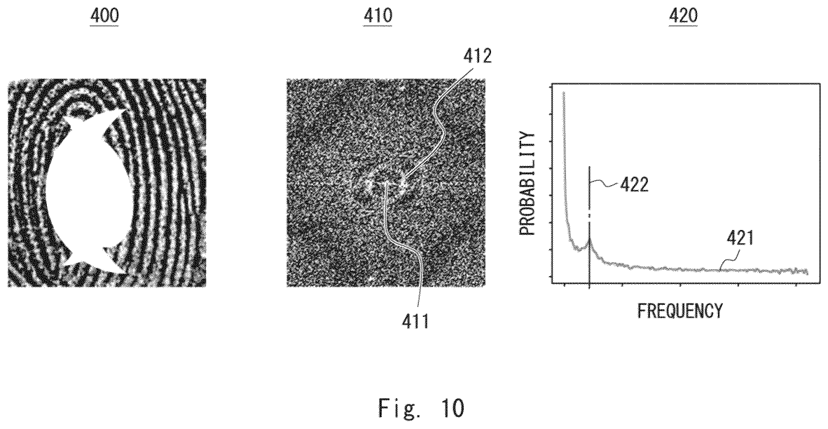

FIG. 10 shows an example of an operation for estimating spatial frequency of a fingerprint according to the fourth example embodiment of the present invention. A tomographic image 400 indicating a fingerprint shown in FIG. 10 is obtained by roughly estimating a depth at which the fingerprint exists and then presenting a tomographic image at the corresponding depth. Examples of a method for roughly estimating the depth include: a method of selecting a depth at which the OCL average value is the maximum, or a depth at which an average value of luminance of a tomographic image is the maximum as described in the third example embodiment; and the like.

A frequency image 410 is formed through Fourier transform of the tomographic image 400. In the frequency image 410, a ring 412 can be observed around a pixel 411 at the center of the image, the ring corresponding to spatial frequency of the fingerprint.

A frequency characteristic 420 graphically shows an average of pixel values at an equal distance from the pixel 411 at the center of the frequency image 410 as a distance from the pixel 411.

In the graph 421, probability is the maximum at the spatial frequency 422, corresponding to a radius from the pixel 411 at the center of the frequency image 410 to the ring 412. The spatial frequency 422 of the fingerprint can thus be identified. By specifying a range of a region so as to include a plurality of stripes on the basis of the spatial frequency 422, an adaptive operation for fingers with different intervals of stripes is made possible.

FIG. 11 is a flowchart showing an example of processing for extracting an authentication image according to the fourth example embodiment of the present invention. The authenticating image extraction apparatus 11 according to the fourth example embodiment performs Step S101 as in the first example embodiment. The authenticating image extraction apparatus 11 calculates spatial frequency of a fingerprint (Step S401). The means for calculating spatial frequency of a fingerprint is exemplified by, but not limited to, a method of roughly identifying a depth at which the fingerprint exists and then acquiring spatial frequency of a tomographic image at the depth through Fourier transform.

The authenticating image extraction apparatus 11 determines a range of division of regions on the XY-plane on the basis of the spatial frequency determined in Step S401, and divides the 3D luminance data into regions on the XY-plane (Step S402). The authenticating image extraction apparatus 11 according to the fourth example embodiment performs Step S103 to Step S108 as in the first example embodiment.

As described above, the authentication image extraction system according to the fourth example embodiment performs the processing of obtaining spatial frequency of a fingerprint of a finger to be recognized, and then configuring a range of a region to be divided on the XY-plane in an adaptive manner. As a result, it is made possible to stably extract a clear fingerprint image for fingers with different fingerprint frequencies.

### Other Example Embodiments

Note that although the present invention is described as a hardware configuration in the above-described first to fourth example embodiments, the present invention is not limited to the hardware configurations. In the present invention, the processes in each of the components can also be implemented by having a CPU (Central Processing Unit) execute a computer program.

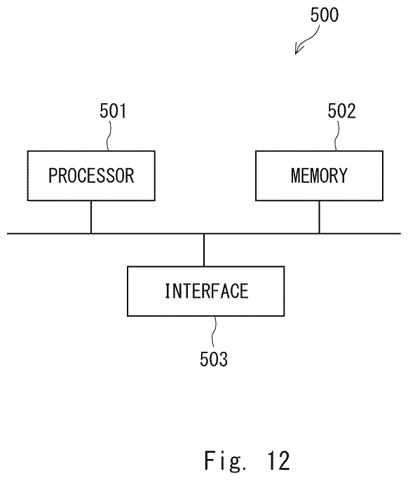

For example, the authenticating image extraction apparatus 11 according to any of the above-described example embodiments can have the below-shown hardware configuration. FIG. 12 shows an example of a hardware configuration included in the authenticating image extraction apparatus 11.

An apparatus 500 shown in FIG. 12 includes a processor 501 and a memory 502 as well as an interface 503. The authenticating image extraction apparatus 11 described in any of the above example embodiments is implemented as the processor 501 loads and executes a program stored in the memory 502. That is, this program is a program for causing the processor 501 to function as the authenticating image extraction apparatus 11 shown in FIG. 1 or a part thereof. This program can be considered to be a program for causing the authenticating image extraction apparatus 11 of FIG. 1 to perform the processing in the authenticating image extraction apparatus 11 or a part thereof.

The above-described program may be stored by using various types of non-transitory computer readable media and supplied to a computer (computers including information notification apparatuses). Non-transitory computer readable media include various types of tangible storage media. Examples of the non-transitory computer readable media include magnetic recording media (e.g., a flexible disk, a magnetic tape, and a hard disk drive), and magneto-optical recording media (e.g., a magneto-optical disk). Further, the example includes a CD-ROM (Read Only Memory), a CD-R, and a CD-R/W. Further, the example includes a semiconductor memory (e.g., a mask ROM, a PROM, an EPROM, a flash ROM, and a RAM). Further, the program may be supplied to a computer by various types of transitory computer readable media. Examples of the transitory computer readable media include an electrical signal, an optical signal, and electromagnetic waves. Transitory computer readable media can provide the program to a computer via a wired communication line (e.g., electric wires, and optical fibers) or a wireless communication line.

Further, as described above as the procedure for processing in the authenticating image extraction apparatus 11 in the above-described various example embodiments, the present invention may also be applied as a processing method.

A part or all of the above-described example embodiments may be stated as in the supplementary note presented below, but is not limited thereto.

### Supplementary Note 1

A processing apparatus comprising:
means for calculating, from three-dimensional luminance data indicating an authentication target, depth dependence of striped pattern sharpness in a plurality of regions on a plane perpendicular to a depth direction of the authentication target;
means for calculating a depth at which the striped pattern sharpness is the greatest in the depth dependence of striped pattern sharpness;
rough adjustment means for correcting the calculated depth on the basis of depths of other regions positioned respectively around the plurality of regions;
fine adjustment means for selecting a depth closest to the corrected depth and at which the striped pattern sharpness is at an extreme; and
means for extracting an image with a luminance on the basis of the selected depth.

### Supplementary Note 2

The processing apparatus described in Supplementary note 1, further comprising:
means for calculating for each region a difference amount between roughly adjusted depth information indicating the corrected depth and finely adjusted depth information indicating the selected depth,
wherein, in a case in which the difference amount is no less than a threshold value,
the rough adjustment means re-corrects the corrected depth on the basis of depths of other regions positioned respectively around the plurality of regions and
the fine adjustment means re-selects, as the re-corrected depth, a depth closest to the re-corrected depth and at which the striped pattern sharpness is at an extreme;
means for calculating for each region a difference amount between roughly re-adjusted depth information indicating the re-corrected depth and finely re-adjusted depth information indicating the re-selected depth; and
means for extracting the image with the luminance on the basis of the re-selected depth in a case in which the difference amount is less than the threshold value.

### Supplementary Note 3

The processing apparatus described in Supplementary note 1 or 2, further comprising means for restricting calculation of the depth dependence of the striped pattern sharpness to a specified depth.

### Supplementary Note 4

The processing apparatus described in any one of Supplementary notes 1 to 3, further comprising means for determining spatial frequency of the striped pattern from the three-dimensional luminance data and then calculating a range of the regions.

### Supplementary Note 5

The processing apparatus described in any one of Supplementary notes 1 to 4, wherein the striped pattern sharpness indicates unidirectionality of the striped pattern in the regions.

### Supplementary Note 6

The processing apparatus described in any one of Supplementary notes 1 to 4, wherein the striped pattern sharpness indicates unity of spatial frequency in the regions.

### Supplementary Note 7

The processing apparatus described in any one of Supplementary notes 1 to 4, wherein the striped pattern sharpness indicates uniformity of luminance in each of light and dark portions in the regions.

### Supplementary Note 8

The processing apparatus described in any one of Supplementary notes 1 to 4, wherein the striped pattern sharpness indicates uniformity with respect to widths of light and dark stripes in the regions.

### Supplementary Note 9

The processing apparatus described in any one of Supplementary notes 1 to 4, wherein the striped pattern sharpness is a combination of the striped pattern sharpnesses described in any of Supplementary notes 5 to 8.

### Supplementary Note 10

The processing apparatus described in any one of Supplementary notes 1 to 9, wherein the rough adjustment means employs a median filter.

### Supplementary Note 11

The processing apparatus described in any one of Supplementary notes 1 to 9, wherein the rough adjustment means employs a bilateral filter.

### Supplementary Note 12

The processing apparatus described in any one of Supplementary notes 1 to 9, wherein the rough adjustment means employs a filter for spatial frequency.

### Supplementary Note 13

A system comprising:
an apparatus configured to acquire three-dimensional luminance data indicating a recognition target; and
the processing apparatus described in any one of Supplementary notes 1 to 12,
wherein the system is configured to acquire a tomographic image having a striped pattern inside the recognition target.

### Supplementary Note 14

A biometric authentication system comprising:
an apparatus configured to acquire three-dimensional luminance data indicating a living body as a recognition target;
the processing apparatus described in to any one of Supplementary notes 1 to 12; and
a processing apparatus configured to compare a tomographic image having a striped pattern inside the recognition target with image data associated with individual information,
wherein the biometric authentication system is configured to identify an individual through comparison between the tomographic image and the image data.

### Supplementary Note 15

A processing method comprising:
a step of calculating, from three-dimensional luminance data indicating an authentication target, depth dependence of striped pattern sharpness in a plurality of regions on a plane perpendicular to a depth direction of the authentication target;
a step of calculating a depth at which the striped pattern sharpness is the greatest in the depth dependence of striped pattern sharpness;
a step of correcting the calculated depth on the basis of depths of other regions positioned respectively around the plurality of regions;
a step of selecting a depth closest to the corrected depth and at which the striped pattern sharpness is at an extreme; and
a step of extracting an image with a luminance on the basis of the selected depth.

### Supplementary Note 16

A non-transitory computer readable medium storing a program causing a computer to perform:
a step of calculating, from three-dimensional luminance data indicating an authentication target, depth dependence of striped pattern sharpness in a plurality of regions on a plane perpendicular to a depth direction of the authentication target;
a step of calculating a depth at which the striped pattern sharpness is the greatest in the depth dependence of striped pattern sharpness;
a step of correcting the calculated depth on the basis of depths of other regions positioned respectively around the plurality of regions;
a step of selecting a depth closest to the corrected depth and at which the striped pattern sharpness is at an extreme; and
a step of extracting an image with a luminance on the basis of the selected depth.

### REFERENCE SIGNS LIST

10 SYSTEM
11 AUTHENTICATING IMAGE EXTRACTION APPARATUS
12 MEASURING APPARATUS
13 SMOOTHING APPARATUS
14 AUTHENTICATION APPARATUS
100, 300 TOMOGRAPHIC IMAGE GROUP
110a, 110b, 310 DEPTH DEPENDENCE OF STRIPED PATTERN SHARPNESS
101, 102, 10k, 10n, 301, 302, 30k, 30n, 400 TOMOGRAPHIC IMAGE
101a, 101b, 3011, 3012, 301m REGION
120a, 120b, 130a, 130b, 140b, 200a, 210a, 210b, 220b, 411 PIXEL
111a, 111b, 311, 421 GRAPH
112a, 112b, 113, 312, 313, 314 DEPTH
412 RING
500 DEVICE
501 PROCESSOR
502 MEMORY
503 INTERFACE

1. A processing apparatus comprising:
one or more processors;
a memory storing executable instructions that, when executed by the one or more processors, causes the one or more processors to perform operations comprising:
determining a searching range for depth that is limited to a range in the reverse to depth direction from a depth which is a median value of first and second depths at which striped pattern sharpness is a maximum;
extracting, from three-dimensional luminance data indicating an authentication target, three-dimensional luminance data within the searching range for depth;
calculating, from the extracted three-dimensional luminance data within the searching range for depth, depth dependence of striped pattern sharpness in a plurality of regions on a plane perpendicular to a depth direction of the authentication target;
calculating a depth at which the striped pattern sharpness is the greatest in the depth dependence of striped pattern sharpness;
correcting the calculated depth on the basis of depths of other regions positioned respectively around the plurality of regions;
selecting a depth closest to the corrected depth and at which the striped pattern sharpness is at an extreme; and
extracting an image with a luminance on the basis of the selected depth.

2. The processing apparatus according to claim 1, wherein the operations further comprise:
calculating, for each region, a difference amount between roughly adjusted depth information indicating the corrected depth and finely adjusted depth information indicating the selected depth,
in a case in which the difference amount is no less than a threshold value, re-correcting the corrected depth on the basis of depths of other regions positioned respectively around the plurality of regions;
re-selecting, as the re-corrected depth, a depth closest to the re-corrected depth and at which the striped pattern sharpness is at an extreme;
calculating, for each region, a difference amount between roughly re-adjusted depth information indicating the re-corrected depth and finely re-adjusted depth information indicating the re-selected depth; and
extracting the image with the luminance on the basis of the re-selected depth in a case in which the difference amount is less than the threshold value.

3. The processing apparatus according to claim 1, wherein the operations further comprise restricting calculation of the depth dependence of the striped pattern sharpness to a specified depth.

4. The processing apparatus according to claim 1, wherein the operations further comprise determining spatial frequency of the striped pattern from the extracted three-dimensional luminance data and then calculating a range of the regions.

5. The processing apparatus according to claim 1, wherein the striped pattern sharpness indicates unidirectionality of the striped pattern in the regions.

6. The processing apparatus according to claim 1, wherein the striped pattern sharpness indicates unity of spatial frequency in the regions.

7. The processing apparatus according to claim 1, wherein the striped pattern sharpness indicates uniformity of luminance in each of light and dark portions in the regions.

8. The processing apparatus according to claim 1, wherein the striped pattern sharpness indicates uniformity with respect to widths of light and dark stripes in the regions.

9. The processing apparatus according to claim 1, wherein the striped pattern sharpness is a combination of the striped pattern sharpnesses that indicates unidirectionality of the striped pattern in the regions, unity of spatial frequency in the regions, uniformity of luminance in each of light and dark portions in the regions and uniformity with respect to widths of light and dark stripes in the regions, respectively.

10. The processing apparatus according to claim 1, wherein the operations further comprise using a median filter.

11. The processing apparatus according to claim 1, wherein the operations further comprise using a bilateral filter.

12. The processing apparatus according to claim 1, wherein the operations further comprise using a filter for spatial frequency.

13. A system comprising:
a measuring apparatus configured to capture three-dimensional luminance data indicating a recognition target; and
the processing apparatus according to claim 1,
wherein the operations further comprise acquiring a tomographic image having a striped pattern inside the recognition target.

14. A biometric authentication system comprising:
a measuring apparatus configured to capture three-dimensional luminance data indicating a living body as a recognition target;
the processing apparatus according to claim 1;
wherein the operations further comprise:
comparing a tomographic image having a striped pattern inside the recognition target with image data associated with individual information; and
identifying an individual through comparison between the tomographic image and the image data.

15. A processing method comprising:
determining a searching range for depth that is limited to a range in the reverse to depth direction from a depth which is a median value of first and second depths at which striped pattern sharpness is a maximum;
extracting, from three-dimensional luminance data indicating an authentication target, three-dimensional luminance data within the searching range for depth;
calculating, from the extracted three-dimensional luminance data within the searching range for depth, depth dependence of striped pattern sharpness in a plurality of regions on a plane perpendicular to a depth direction of the authentication target;
calculating a depth at which the striped pattern sharpness is the greatest in the depth dependence of striped pattern sharpness;
correcting the calculated depth on the basis of depths of other regions positioned respectively around the plurality of regions;
selecting a depth closest to the corrected depth and at which the striped pattern sharpness is at an extreme; and
extracting an image with a luminance on the basis of the selected depth.

16. A non-transitory computer readable medium storing a program, which if executed, causes a computer to perform operations comprising:
determining a searching range for depth that is limited to a range in the reverse to depth direction from a depth which is a median value of first and second depths at which striped pattern sharpness is a maximum;
extracting, from three-dimensional luminance data indicating an authentication target, three-dimensional luminance data within the searching range for depth;
calculating, from the extracted three-dimensional luminance data within the searching range for depth, depth dependence of striped pattern sharpness in a plurality of regions on a plane perpendicular to a depth direction of the authentication target;
calculating a depth at which the striped pattern sharpness is the greatest in the depth dependence of striped pattern sharpness;
correcting the calculated depth on the basis of depths of other regions positioned respectively around the plurality of regions;
selecting a depth closest to the corrected depth and at which the striped pattern sharpness is at an extreme; and
extracting an image with a luminance on the basis of the selected depth.
